(19) United States
(12) Patent Application Publication
(10) Pub. No.: US 2005/0001059 A1
(43) Pub. Date: Jan. 6, 2005

(54) Robbery control sprayer

(76) Inventor: Chi-Hong Yang, Changhua City (TW)

Correspondence Address: RABIN & BERDO, P.C., Suite 500, 1101 14th Street, N.W., Washington, DC, 20005, US

(21) Appl. No.: 10/610,643

(22) Filed: Jul. 2, 2003

(51) Int. Cl. B05B 1/28

(52) U.S. Cl. 239/290

(57) ABSTRACT

This invention discloses a robbery control sprayer, comprising a water-soluble dye spray used for spraying at a robber (or a criminal) by exerting an external force to the sprayer, so that any part of the robber's body or the transportation used for escape is sprayed with the dye, and the robber having no easy way to hide can be identified by the public, and thus facilitating the arrest and breaking the case as well as stopping robberies and crimes.

### BACKGROUND OF THE INVENTION

1. Field of the Invention

This invention relates to a robbery control sprayer, more particularly to a robbery control spray that can quickly mark a criminal's body or transportation means within 5 seconds after a crime is committed, so that the public can identify the criminal to facilitate the arrest and stop robberies and crimes.

2. Description of the Related Art

Recently, the social ethics gets worse day after day, and the public order is gradually corrupted; robberies as serious as bank robbery and cash-carrier vehicle robbery, or as small as street robberies are common. In some cases, the robber may even shoot the security guard of the armored cash-carrier. The crime rate is increasing, and the people's life is threatened and unease. However, the safeguard of the public security relies on the police to seize and capture the criminals all the time. Since the police force and clues are limited, and the robbery clearance is prolonged and ineffective. According to the statistics posted on the network by the Police Department, the number of robberies occurred in Taiwan district in the past three years includes 4729 in year 2000 with a clearance rate of 40.39%, 7819 in 2001 with a clearance rate of 39.66%, and 7880 in 2002 with a clearance rate of 50.06%. The annual crime rate is increased by 65.34% from 2000 to 2001, and 66.63% from 2000 to 2002. The statistics show that the annual crime rate of Taiwan is increasing. Why the criminals rob in daytime with no fear of being arrested? From the view point of the analysis of criminal psychology, most crimes are conducted by criminals who think they can escape from the spot quickly and then have a good chance of hiding themselves. After a suspect leaves the crime spot, the police or even the eye-witnesses are difficult to follow the clue to arrest the criminal, because the criminal did not leave any special features for the public to trace, and the police cannot sufficiently and timely control the information about the suspect's characteristics and the escape direction. As a result, the criminal has a good chance to escape, and that makes it more difficult to break a case at a later date. This problem is also faced by the police looking for a way for quick clearance of criminal cases. In view of having no effective way to improve the poor public security and the low clearance rate at present, the applicant of this invention invented a robbery control spray, and hereby submitted for patent application.

### SUMMARY OF THE INVENTION

The objective of this invention is to provide a robbery control spray that can mark the body or the transportation means of a criminal by a victim or eye witness when a crime is conducted. The public or police can follow such glue to capture the criminal, stop the criminal from having the motive of conducting a crime with the high expectation on a successful escape in order to reduce crime rate. As far as the robber' skin, car, or motorcycle is dyed, any rinse will expand the dying area and prominently show the robber's appearance and facilitate the identification and arrest.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective diagram of the jet spray cylindrical structure of the present invention.

FIG. 2 is a perspective diagram of the disassembled parts of the present invention.

FIG. 3 is an illustrative diagram of the water-soluble dye spray solution being filled into the spray according to the present invention. When an external force is exerted, the cover of the nozzle at the front end will be detached, and the spray solution is sprayed out.

FIG. 4 is a reference diagram of the simulation of the criminal body being sprayed by the dye spray according to the present invention.

FIG. 5 is a reference diagram of the simulation of the criminal body being sprayed by single hand of a user whose hand is injured or disabled according to the present invention.

FIG. 6 is a perspective diagram of the disassembled parts of a dual jet spray cylindrical structure according to another preferred embodiment of the present invention.

FIG. 7 is a perspective diagram of an assembled dual jet spray cylindrical structure according to another preferred embodiment of the present invention.

FIG. 8 is a reference diagram of the simulation of a criminal body being sprayed by the dye spray of the dual jet spray cylindrical structure according to the present invention.

### DETAILED DESCRIPTION OF THE PREFERRED EMBODIMENTS

Detailed description of the components and physical embodiment of this invention accompanied with diagrams and labeled numbers are given as follows:

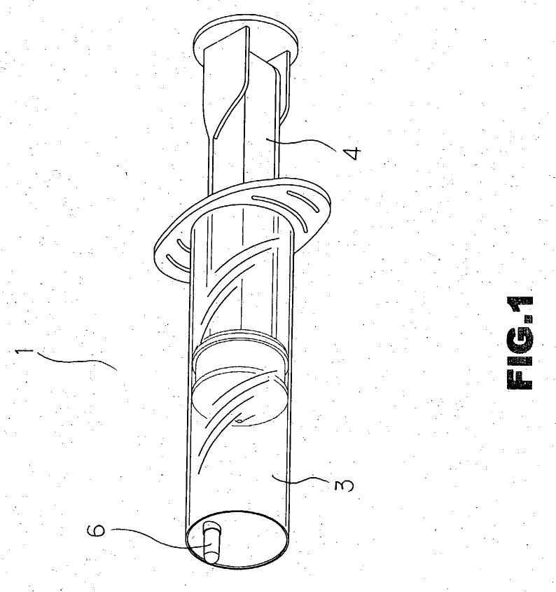

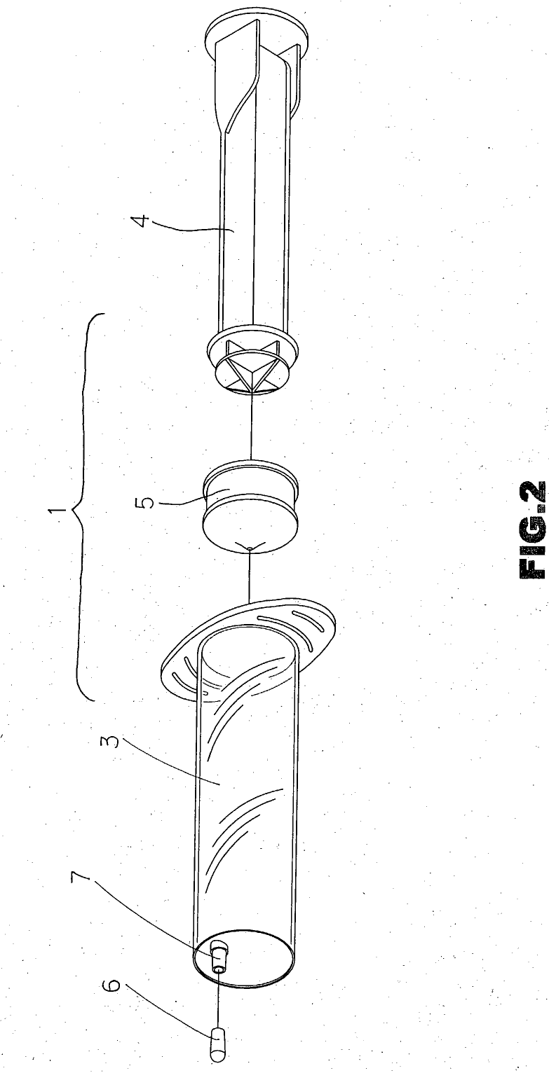

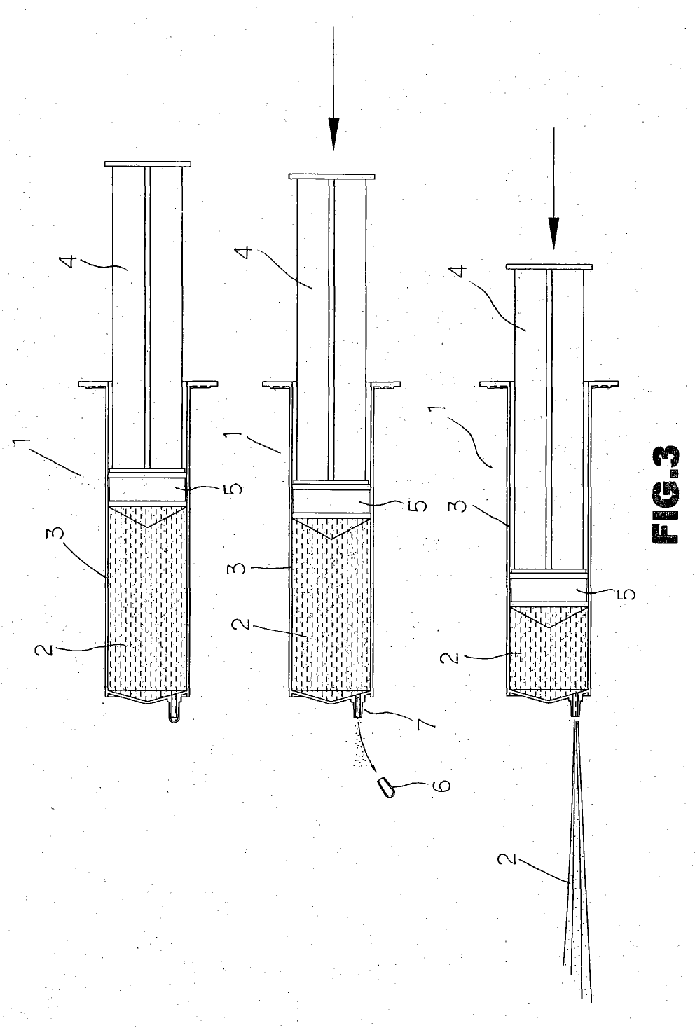

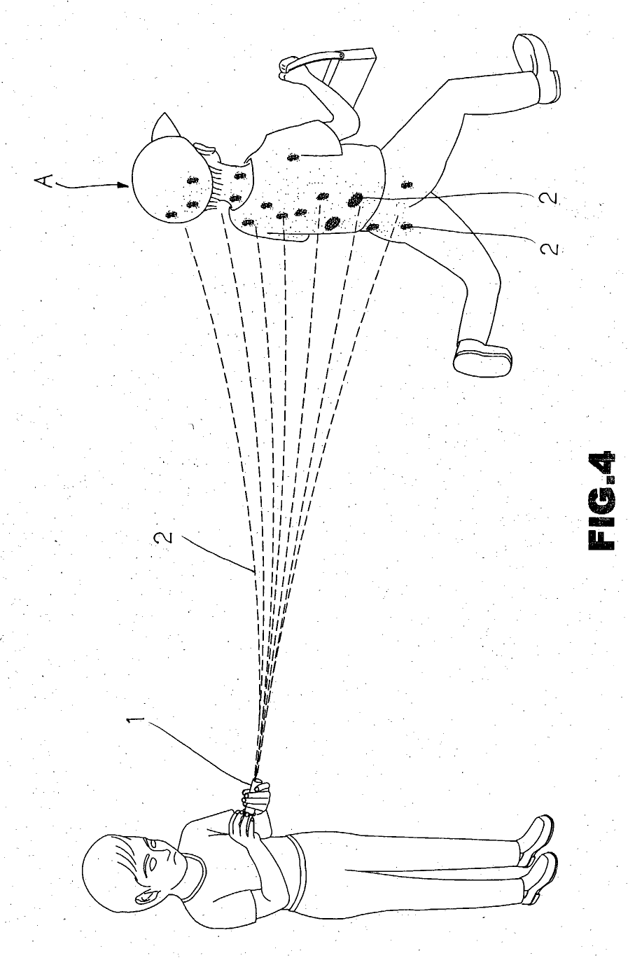

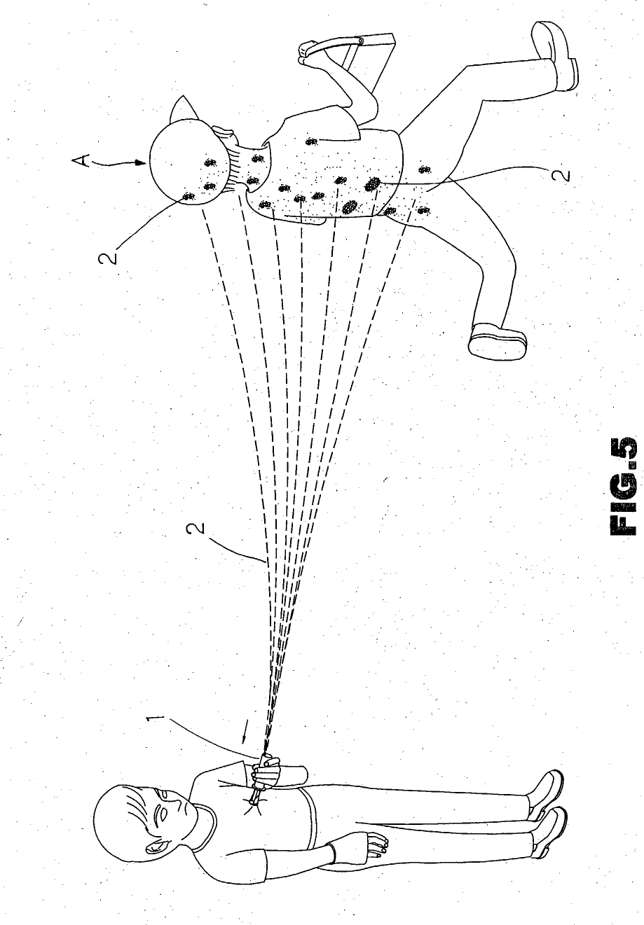

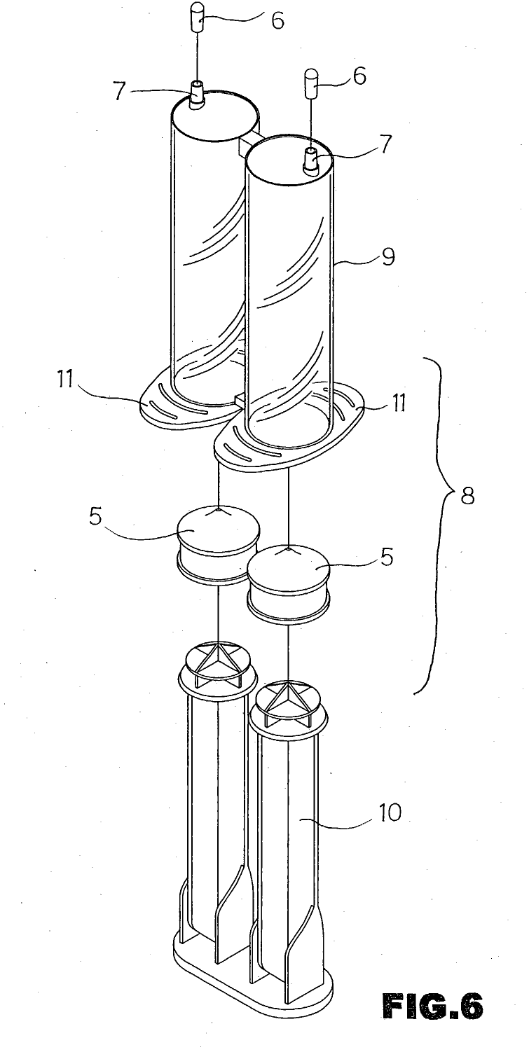

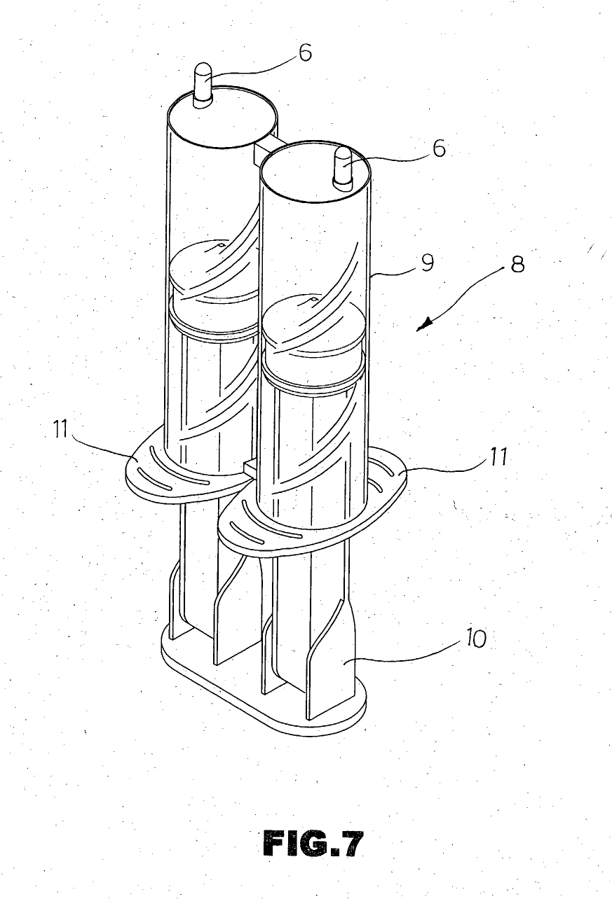

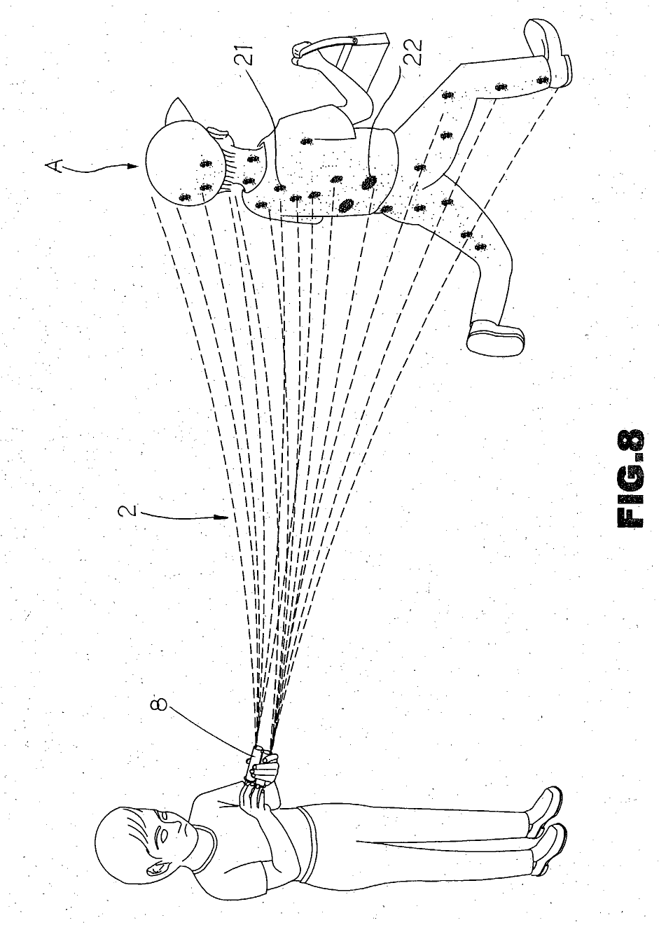

Firstly, refer to the figures. FIG. 1 is the perspective diagram of the single jet spray cylindrical structure adopted by this invention. FIG. 2 is the perspective diagram of the disassembled parts of the single spray jet spray cylindrical structure of this invention. FIG. 3 is an illustrative diagram of the color water-soluble dyed spray solution being filled into the jet spray cylindrical structure, and the action of the color spray solution being ejected out from the nozzle when the cover is separated by acting external force onto it. FIG. 4 is a reference diagram of the simulation of a criminal's body being sprayed by the color dye spray solution ejected from the single jet spray cylindrical structure. FIG. 5 is a reference diagram of the simulation of a criminal being sprayed by the user whose hand is hurt or disabled. FIG. 6 is the perspective diagram of the disassembled parts of the dual jet spray cylindrical structure according to another preferred embodiment of this invention. FIG. 7 is a perspective diagram of the assembled structure of the dual jet spray cylindrical structure according to another embodiment of this invention. FIG. 8 is a reference diagram of the simulation of a criminal's body being sprayed by the color dyed spray solution ejected from the dual spray jet cylindrical structure.

Please refer to FIGS. 1 and 2. The present invention comprises a jet spray cylinder 1 and a water-soluble dyed spray solution 2, wherein the jet spray cylinder 1 comprises a cylindrical body 3, an extracting member 4, a rubber head 5, and a cover 6, and the rubber head is coupled to the front end of the extracting member 4 such that the extracting member 4 can be disposed in the cylindrical body 3 to suck a dye spray solution 2, and a nozzle 7 is disposed at the front end of the cylindrical body 3 which is covered by a cover 6 to prevent the dye spray solution 2 spilling out from the nozzle 7.

Further, the dye spray solution 2 is made of a water-soluble dye, such as No. 5 acidic Gold, No. 7 Rodamine, or Merbromin dyes, and the adhesiveness of such dye is can last more than 5 days, and can be effectively adhered onto most substances and metals. It is necessary to check the nozzle 7 if it is clogged from time to time and gently shake the dye.

Please refer to FIGS. 3, 4, and 5. When the robbery control spray according to the present invention is in use, the user holds the cylindrical body 3 by one hand, and the palm of the other hand presses the lower edge of the extracting member 4 to aim at the target and push forward. Then the nozzle 7 at the front end of the cylindrical body 3 timely detaches the cover 6 and easily sprays the dye spray solution 2 at the moving robber A. The range of shooting of this invention is close to 7 meters (approximately equal 23 feet), and 10 ml (ml=millimeter or c.c.) of dye are sprayed per second. The spray for all models of these products can be fully exhausted within 5 seconds. If a robber A is prayed, the robber's body will be dyed as simulated in FIG. 4, such that the robber can be identified by the public and has no way to hide, which facilitates the arrest and stops robberies and crimes.

Further, if the hand of the user is injured or disabled, the jet spray cylinder can be operated to shoot at the criminal as shown in FIG. 5. It will not cause problem in such use.

Please refer to FIGS. 6 and 7 for another embodiment of this invention, which comprises:

A dual jet spray cylinder 8, composed of two independent and connected cylindrical bodies 9, and two extracting members 10 with their bottoms connected to each other, two rubber heads 5 and two covers 6, and the rubber head covers the front end of the extracting member 10 such that the extracting members 10 can be individually disposed in the cylindrical bodies, and a nozzle 7 at the front end of the cylindrical body 9 is covered by a cover 6. Since a stop section is protruded from the lower section of the cylindrical body 9, such stop section can block the edge of the user's hand to avoid it from being slipped.

If Merbromin dye and one of the foregoing dye spray solutions 2 including No. 5 Gold or No. 7 Rodamine are used, these dye solutions are respectively filled into the cylindrical bodies 9 of the dual jet spray cylinder 8.

Please refer to FIG. 8. At that time, after the robber A is sprayed by the dye spray solution 2, regardless of the color the robber A is wearing or the color of the transportation means, the two different color of the dark dye spray solution 21 and the light dye spray solution 22 solve the problems caused by the dark or light color of the robber's clothes. It makes the robber easily be identified by the public and facilitates the police to arrest the criminal, and attains the purpose of stopping robberies and crimes.

[Type of Spray Product and Total Weight of Finished Goods of this Invention]

Single Jet Spray Cylindrical Structure:

5 ml (about 15 g) 10 ml (about 25 g), 20 ml (about 45 g) 30 ml (about 55 g), 50 ml (about 95 g) where (ml=cc)

Dual Jet Spray Cylindrical Structure:

5 ml (about 30 g), 10 ml (about 50 g) 20 ml (about 90 g), and 30 ml (about 110 g)

where (ml=cc)

[Applicable for Domestic and Foreign Industries]

Bank, Credit Union, Post Office, Agricultural and Fishery Union, Vegetable and Fruit Merchant, Cash Carrying Vehicle, Security, Jewelry, Jewelry Store, Gold Manufacture, Watch Store, Supermarket, Pawn Shop, Hawker, Lottery Industry, Store, Individual, Protest, and Riot. The product according to this invention facilitates the police to collect evidence or prevent robbery, which is also the best defensive tool for women going out at nights.

The Expected Functions of the Robbery Control Spray According this Invention:

1. It does not require battery or power supply.

2. It is light, easy-to-carry, and has a 360° control, such that the criminal has no way to hide.

3. It is portable and easy-to-store, which is the best burglarproof and self-defense tool.

4. When it is in use, hold the cylinder by one hand, and use the palm of the other hand to push the cylinder forward and aim at the moving robber for the spray.

5. It can be sprayed at any part of the robber's body or escaping tools such as a car or motorcycle.

6. The robber can be identified easily by the public to facilitate the arrest and stop robberies and crimes.

7. It has no toxic, pollution, environmental protection, or medical problems, the jet spray cylinder can be recycled after its use.

8. The shooting range for both single and double jet spray cylinders is from nearby to 7 m (about 23 ft.); 10 ml (ml=millimeter or c.c.) of dye is sprayed per second; and all spray of the product of each model can be exhausted within 5 seconds.

9. The dye can be attached to most materials such as metal, plastic, glass, clothes, leather and human skin (for about 5 days), safety helmet, and protective hood, etc.

10. The manufacturing cost is low, and users can buy such product with a low price, which facilitate its promotion.

11. When the dual jet spray cylinder is used, two different colors can solve the problem when the robber is wearing either dark or light color clothes.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

1. A robbery control spray, comprising:
a single jet spray cylinder, composed of a cylindrical body, an extracting member, a rubber head, and a cover, and said rubber head being covered onto the front end of said extracting member such that said extracting member being disposed into said cylindrical body, and a nozzle at the front end of said cylindrical body being covered by said cover;
a dye spray solution, made of a material of water-soluble color dye, being one selected from the collection of No. 5 Gold, No. 7 Rodamine, and Merbromin dyes, and filled into the cylindrical body of said jet spray cylinder;
when said cylindrical body being held by one hand of a user, and the lower edge of said extracting member being pressed by a palm of the other hand of the user, and a force being exerted onto the extracting member to aim at a target, such that the cover being detached from a nozzle at the front end of said cylindrical body, and the dye spray solution being sprayed at the moving robber or transportation means for escape, and the robber being easily identified by the public to facilitate the arrest by the police, and stopping robberies and crimes.

2. A robbery control spray, comprising:
a dual jet spray cylinder, composed of two independent and connected cylindrical bodies having two extracting members coupled at their bottoms, two rubber heads, and two covers, and said rubber heads being covered onto the front end of said extracting members respectively such that said extracting members being disposed into said cylindrical body, and a nozzle at the front end of said cylindrical body being covered by said cover;
a dye spray solution, made of a material of water-soluble color dye, being one selected from the collection of No. 5 Gold, No. 7 Rodamine, and Merbromin dyes, and filled into the cylindrical body of said jet spray cylinder;
when said cylindrical body being held by one hand of a user, and the lower edge of said extracting member being pressed by a palm of the other hand of the user, and a force being exerted onto the extracting member to aim at a target, such that the cover being detached from a nozzle at the front end of said cylindrical body, and the dye spray solution being sprayed at the moving robber or transportation means for escape, and the robber being easily identified by the public to facilitate the arrest by the police, and stopping robberies and crimes.

3. The robbery control spray of claim 1, wherein sand jet spray cylinder can spray at a robber with a mechanical jet spray in 360 degrees, and the shooting range covers from nearby to 7 meters (approximately 23 meters), and the spray solution selected from the collection of 5 ml, 20 ml, 30 ml, and 50 ml can be exhausted within 5 seconds.
